(19) United States
(12) Patent Application Publication
(10) Pub. No.: US 2011/0234655 A1
(43) Pub. Date: Sep. 29, 2011

(54) Driving Method and Related Driving Module

(76) Inventors: Syang-Yun Tzeng, Taoyuan County (TW); Chin-Hung Hsu, Tao-Yuan Hsien (TW)

(21) Appl. No.: 13/069,414

(22) Filed: Mar. 23, 2011

(30) Foreign Application Priority Data
Mar. 26, 2010 (TW) 099109090

(51) Int. Cl. G09G 5/02; G09G 3/36

(52) U.S. Cl. 345/698; 345/87

(57) ABSTRACT

A driving method is provided for eliminating bright and dark lines in an LCD device. The driving method includes control different charging sequences to charge a plurality of pixels deposited in a first row and corresponding to a data line and a plurality of pixels deposited in a second row and corresponding to the data line.

### BACKGROUND OF THE INVENTION

1. Field of the Invention

The present invention relates to a driving module and driving method, and more particularly, to a driving module and driving method utilizing different charging sequences to charge pixels deposited in different rows and corresponding to a same data line in a liquid crystal display (LCD) device, to eliminate bright and dark lines.

2. Description of the Prior Art

LCD devices have merits such as low radiation, compact size and low power consumption, and thus have replaced conventional cathode ray tube (CRT) devices gradually, so as to be widely used in laptops, personal digital assistants (PDAs), flat TVs or mobile phones. Generally, an LCD device utilizes a source driver and a gate driver to drive pixels on a panel to display images. Since cost of a source driver is higher than that of a gate driver, in order to reduce the amount of source drivers, a dual gate structure (half source driver, HSD), in which data lines are shared by pixels, is thus developed. In short, for the same amount of pixels, the dual gate structure has half as many data lines, and twice as many scan lines, for reducing the cost. However, since a gate driving signal has only half of the conventional active cycle, a data line can only charge pixels with half of the conventional charging time, the pixels are charged insufficiently.

Besides, in order to avoid repeatedly driving liquid crystal molecules with voltages having the same polarity (positive or negative), thereby reducing polarization or refraction properties of the liquid crystal molecules, which deteriorates image quality, the liquid crystal molecules need to be driven by positive and negative voltage alternately, such as by one line inversion, two line inversion, column inversion and so on. Since the dual gate structure has shared data lines, the dual gate structure generally adopts the two line inversion, which charges two pixels on the same row corresponding to a shared data line with voltage of one polarity (controlled by two scan lines, respectively), and two pixels on the next row with voltage of opposite polarity.

Please refer to FIG. 1, which is a schematic diagram of driving pixels of an LCD device 10 according to a Z-shaped sequence in the prior art. For clear illustration, the LCD device 10 only includes a source driver 100, a gate driver 102, a timing controller 104 and an LCD panel 106. The LCD panel 106 is a dual gate structure, and includes data lines CH_1-CH_p, scan lines GL_1-GL_q and a pixel matrix Mat. In the pixel matrix Mat, each pixel includes a transistor and a capacitor, which are denoted by blocks for simplicity. In the view of columns, pixels of every two columns are controlled by the same data line. For example, red pixels R1-Rn and green pixels G1-Gn are controlled by the data line CH_1, blue pixels B1-Bn and red pixels R1′-Rn′are controlled by the data line CH_2, green pixels G1′-Gn′ and blue pixels B1′-Bn′ are controlled by the data line CH_3, and so on. In the view of rows, pixels of each row are controlled by two adjacent scan lines. For example, in a row Row_1, the red pixel R1, the blue pixel B1 and the green pixel G1′ are controlled by the scan line GL_1, and the green pixel G1, the red pixel R1′ and the blue pixel B1′ are controlled by the scan line GL_2. Other rows Row_2, Row_3 . . . Row_n are arranged by the same token.

When the pixels of the LCD device 10 are driven according to a Z-shaped sequence, the timing controller 104 controls magnitudes, polarities, and timings of signals outputted by the data lines CH_1-CH_p and scan lines GL_1-GL_q via the source driver 100 and the gate driver 102, to charge the pixels of the pixel matrix Mat in the Z-shaped sequence. That is, as dot lines shown in FIG. 1, the pixels of the data line CH_1 are charged in a sequence of R1→G1→R2→G2 . . . , and so on. However, the Z-shaped driving method charges the green pixels G1-Gn of the data line CH_1 more and the green pixels G1′-Gn′ of the data line CH_3 less, causing vertical bright and dark lines.

Please refer to FIG. 2, which is a schematic diagram of waveforms of two-line inversion driving signals outputted by the data lines CH_1-CH_3 in FIG. 1. Since human eyes are more sensitive to green light, a green image, which charges red and blue pixels more and green pixels less to display a green image, is utilized for testing bright and dark lines. As shown in FIG. 2, under the Z-shaped driving, the data line CH_1 charges pixels in a sequence of R1→G1→R2→G2 . . . . When a pixel is charged, if a previous pixel is charged with a different polarity, a charging voltage needs longer settling time, e.g. for the pixels R1, R2, which combined with less charging time likely causes the pixel to be charged insufficiently. For example, the pixels R1, G1 of the row Row_1 and the pixels R2, G2 of the row Row_2 are charged with different polarities, such that the red pixels R1, R2 are charged less and the green pixels G1, G2 are charged more. Similarly, the data line CH_3 charges the green pixels G1′, G2′ less and the blue pixels B1′, B2′ more. By the same token, the green pixels G1-Gn of the data line CH_1 are charged more, and are darker in a normally white LCD panel, while the green pixels G1′-Gn′ of the data line CH_3 are charged less, and are brighter in the normally white LCD panel, causing the vertical bright and dark lines.

Therefore, for the dual gate pixel structure driven by the two-line inversion method, since the pixels are driven in the Z-shaped driving sequence, the pixels of each row corresponding to the same data line are charged in the same sequence, such that the pixels on one side of the data line are charged more, causing the vertical bright and dark lines. Thus, there is a need for improvement.

### SUMMARY OF THE INVENTION

It is therefore an objective of the present invention to provide a driving module and driving method.

The present invention discloses a driving method, for eliminating bright and dark lines in a liquid crystal display (LCD) device. The driving method includes utilizing different charging sequences to charge a plurality of pixels deposited in a first row and corresponding to a data line and a plurality of pixels deposited in a second row and corresponding to the data line.

The present invention further discloses a driving module, for eliminating bright and dark lines in a liquid crystal display (LCD). The driving module includes a data line signal processing unit, for generating a plurality of data driving signals according to a synchronization signal, a scan line signal processing unit, for according to an output enable signal, generating a plurality of gate driving signal, and a control unit, for generating the synchronization signal and the output enable signal, to control the data line signal processing unit and the scan line signal processing unit, to utilize different charging sequences to charge a plurality of pixels deposited in a first row and corresponding to a data line and a plurality of pixels deposited in a second row and corresponding to the data line.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of driving pixels of a LCD device 10 according to a Z-shaped sequence in the prior art.

FIG. 2 is a schematic diagram of waveforms of two-line inversion driving signals outputted by the data line in FIG. 1.

FIG. 3 is a schematic diagram of a driving module according to an embodiment of the present invention.

FIG. 4 is a schematic diagram of driving pixels with a “222” sequence according to an embodiment of the present invention.

FIG. 5 is a schematic diagram of waveforms of two-line inversion driving signals outputted by the data lines in FIG. 4,

FIG. 6A and FIG. 6B are schematic diagrams of output signals of the scan lines and the data line in an odd frame and an even frame, respectively, when pixels are driven in a “222-555” sequence.

FIG. 7 is a schematic diagram of the driving process 70 according to an embodiment of the present invention.

### DETAILED DESCRIPTION

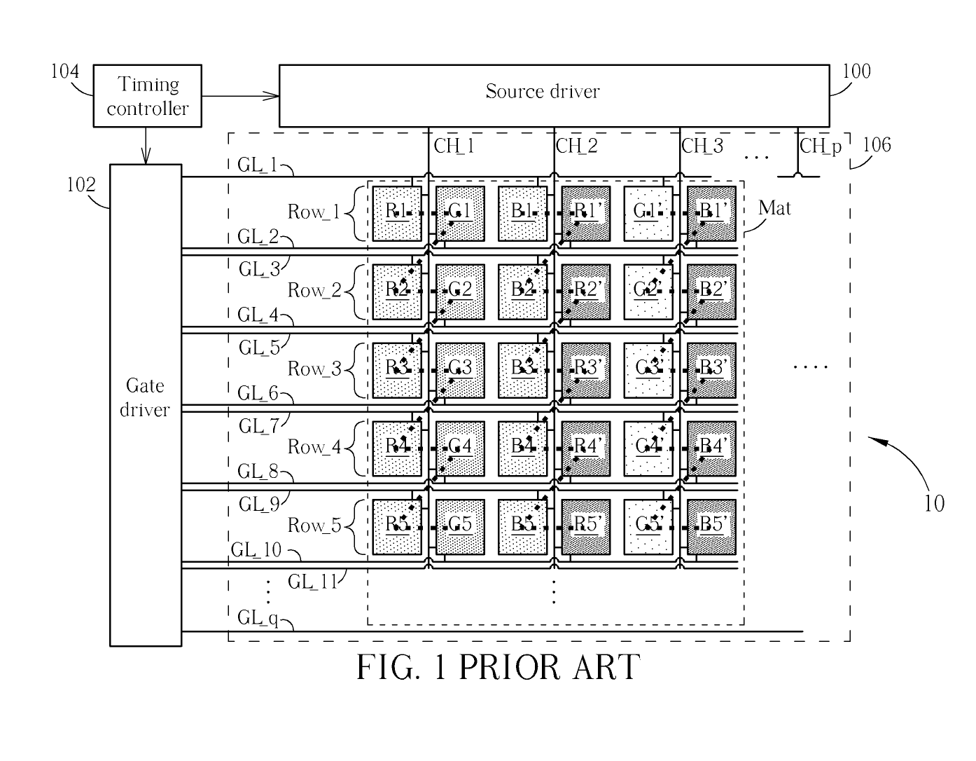

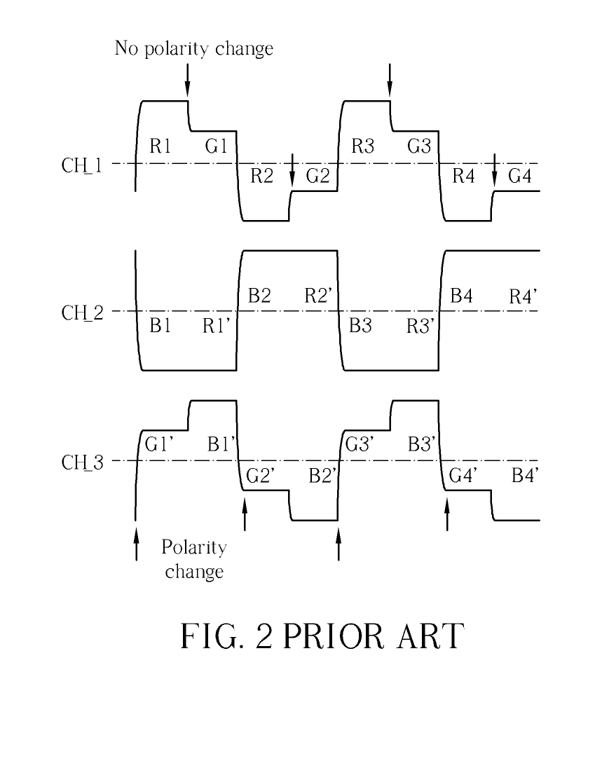

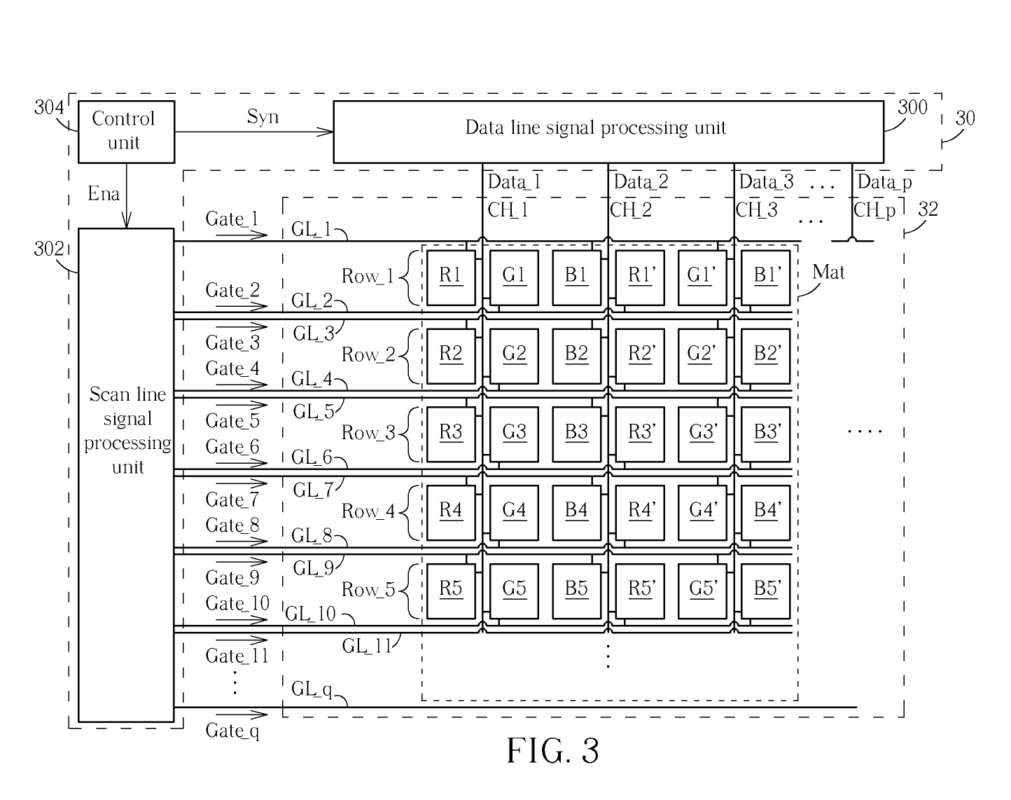

Please refer to FIG. 3, which is a schematic diagram of a driving module 30 according to an embodiment of the present invention. The driving module 30 drives an LCD panel 32, to eliminate bright and dark lines. The LCD panel 32 has a dual gate structure, which is the same as that of the LCD panel 106 in FIG. 1. Therefore, for clear illustration, reference symbols and names of elements of the LCD panel 32 denoted by the same reference symbols and names as elements of the LCD panel 106 in FIG. 1 have similar structure and function. The driving module 30 includes a data line signal processing unit 300, a scan line signal processing unit 302 and a control unit 304. The control unit 304 generates a synchronization signal Syn and an output enable signal Ena, to control the data line signal processing unit 300 and the scan line signal processing unit 302, so as to output data driving signals Data_1-Data_p to the data lines CH_1-CH_p, and gate driving signals Gate_1-Gate_q to scan lines GL_1-GL_q. In order to avoid bright and dark lines, the control unit 304 controls the data line signal processing unit 300 and the scan line signal processing unit 302, to utilize different charging sequences to charge pixels deposited indifferent rows and corresponding to the same data line.

In short, the present invention adjusts the data driving signals Data_1-Data_p and the gate driving signals Gate_1-Gate_q, to utilize different charging sequences to charge the pixels deposited indifferent rows and corresponding to the same data line. For example, according to the concept of the present invention, the red pixels R1-Rn and the green pixels G1-Gn corresponding to the same data line CH_1 can be charged in a sequence of R1→G1→G2→R2→R3→G3→G4→R4 . . . , i.e. pixels deposited in the odd rows Row_1, Row_3, Row_5 . . . are charged from left to right, and pixels deposited in the odd rows Row_2, Row_4, Row_6 . . . are charged from right to left. As a result, pixels deposited in adjacent rows of the LCD panel 32 are charged in different sequences, which avoids charging pixels on one side of a data line more (or less).

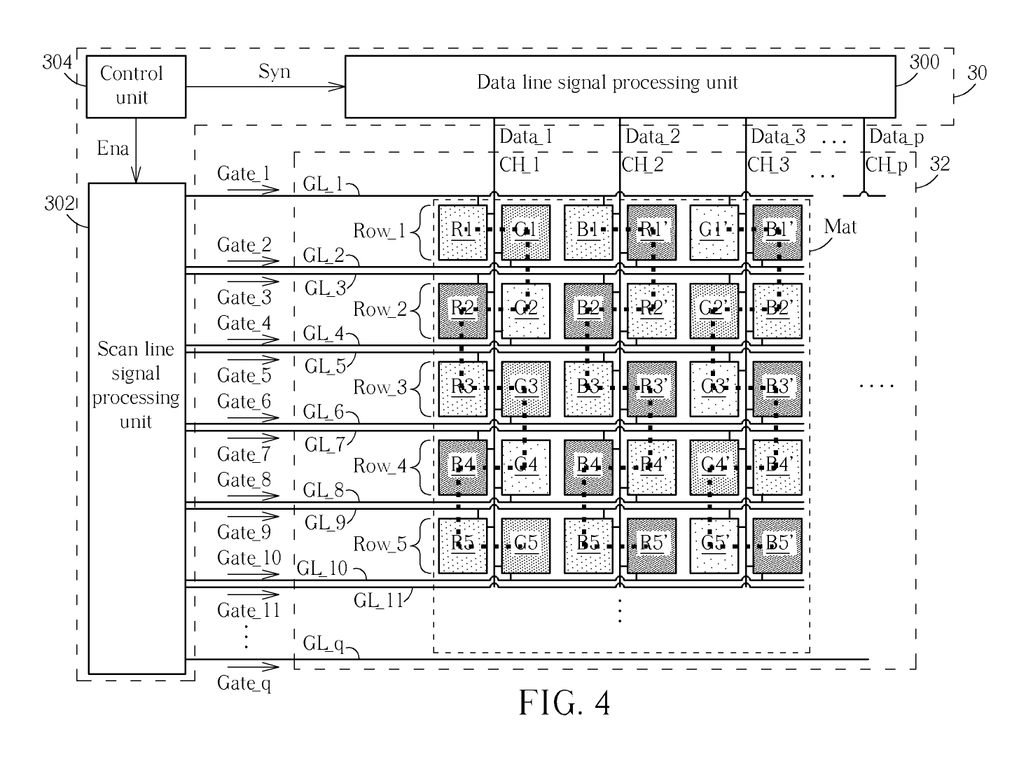

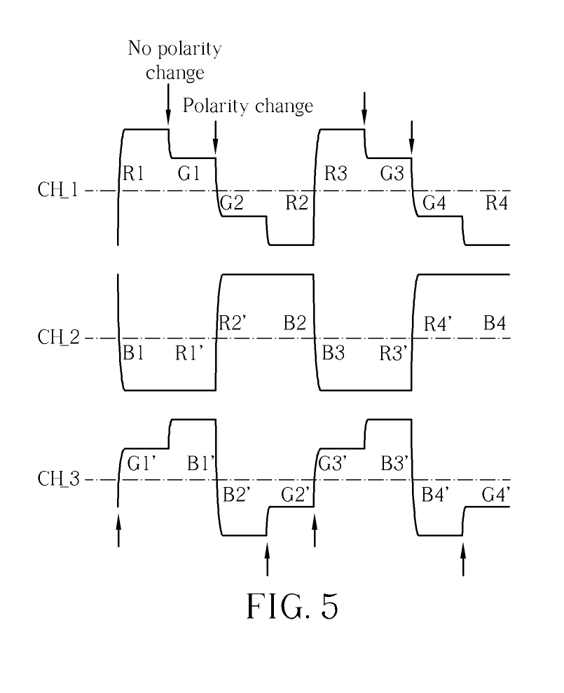

The above exemplary embodiment with different charging sequences for the adjacent rows can be called a “222” driving sequence. In more detail, please refer to FIG. 4 and FIG. 5. FIG. 4 is a schematic diagram of driving pixels with the “222” sequence according to an embodiment of the present invention, and FIG. 5 is a schematic diagram of waveforms of two-line inversion driving signals outputted by the data lines CH_1-CH_3 in FIG. 4. In FIG. 4, the pixels of the pixel matrix Mat are charged in the “222” sequence, i.e. as dot lines, the pixels of the data line CH_1 are charged in a sequence of R1→G1→G2→R2 . . . , and the pixels of the data line CH_2 are charged in a sequence of B1→R1′→R2′→B2 . . . , and so on. Under such a situation, since the pixels of the data line CH_1 are charged in the sequence of R1→G1→G2→R2 . . . , and the pixels R1, G1 of the row Row_1 and the pixels G2, R2 of the row Row_2 are charged with different polarities, the pixels R1, G2 are charged less and the green pixels G1, R2 are charged more. By the same token, the green pixels G1, G3 . . . of the data line CH_1 and deposited on the odd rows are charged more, while the green pixels G2, G4 . . . deposited on the even rows are charged less, such that the green pixels G1-Gn of the data line CH_1 are not entirely charged more or less, so as to cause dark lines or bright lines. Similarly, the green pixels of other data lines are not entirely charged more or less as well, As a result, the present invention can avoid bright and dark lines.

Noticeably, the above description is only an embodiment of the present invention. The spirit of the present invention is to charge pixels deposited in different rows and corresponding to the same data line with different charging sequences, such that pixels on one side of the data line are not charged more or less, so as to eliminate vertical bright and dark lines. Those skilled in the art may make alterations or modifications according to the concept of the present invention. For example, the scan line signal processing unit 302 should properly adjust an output sequence of the gate driving signals Gate_1-Gate_q for different charge sequences. Take FIG. 4 for example. The scan line signal processing unit 302 outputs the gate driving signals Gate_1-Gate_q in a sequence of Gate_1→Gate_2→Gate_4→Gate_3→Gate_5→Gate_6→Gate_8→Gate_7 . . . . In other words, after outputting the gate driving signals Gate_1, Gate_2, the scan line signal processing unit 302 outputs the gate driving signal Gate_4 first and then outputs the gate driving signal Gate_3. For avoiding such an interlaced sequence, the scan lines GL_3 and GL_4 can be exchanged (i.e. the scan line GL_3 drives the pixel G2 and the scan line GL_4 drives the pixel R2), the scan lines GL_7 and GL_8 are exchanged, and so on, such that the scan line signal processing unit 302 outputs the gate driving signals in a sequence of up to down. Noticeably, how the scan line signal processing unit 302 outputs the gate driving signals Gate_1-Gate_q and how the data line signal processing unit 300 and the control unit 304 are realized do not affect the scope of the present invention, as long as the pixels deposited in different rows and corresponding to the same data line are charged in different charging sequences, so as to avoid or lessen bright and dark lines.

In addition, the present invention is not limited to the dual gate structure, and the concept of the present invention can be applied in a tri-gate structure and so on. Moreover, pixels deposited in the same row and corresponding to different data lines can also be charged in different charging sequences, i.e. the charging sequence can be a “255” sequence, a “252” sequence, etc., and not limited to the “222” sequence. The “255” sequence indicates that the pixels of the data line CH_1 are charged in a sequence of R1→G1→G2→R2→R3→G3→G4→R4 . . . , the pixels of the data line CH_2 are charged in a sequence of R1′→B1→B2→R2′→R3′→B3→B4→R4′. . . , the pixels of the data line CH_3 are charged in a sequence of B1′→G1′→G2′→B2′→B3′→G3′→G4′→B4′ . . . , and so on. The “252” sequence indicates that the pixels of the data line CH_1 are charged in a sequence of R1→G1→G2→R2→R3→G3→G4→R4 . . . , the pixels of the data line CH_2 are charged in a sequence of R1′→B1→B2→R2′→R3′→B3→B4→R4′ . . . , the pixels of the data line CH_3 are charged in a sequence of G1′→B1′→B2′→G2′→G3′→B3′→B4′→G4′ . . . , and so on. The “255” charging sequence or “252” charging sequence can avoid vertical bright and dark lines as well.

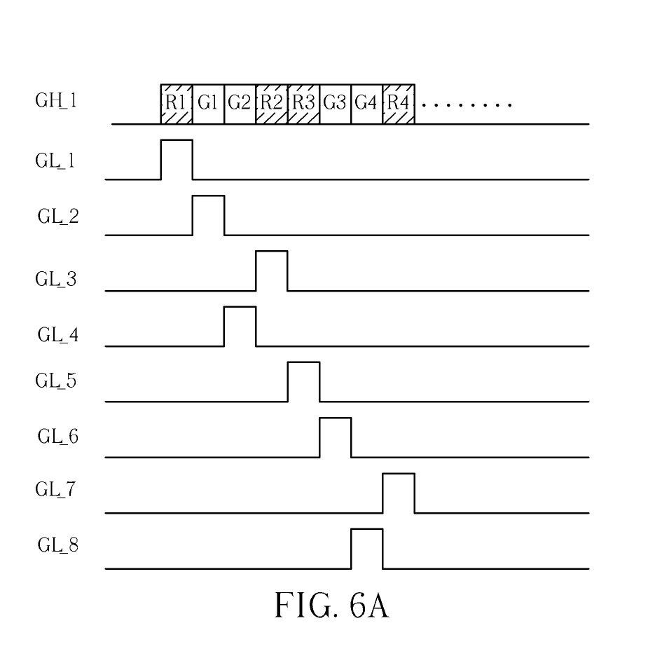

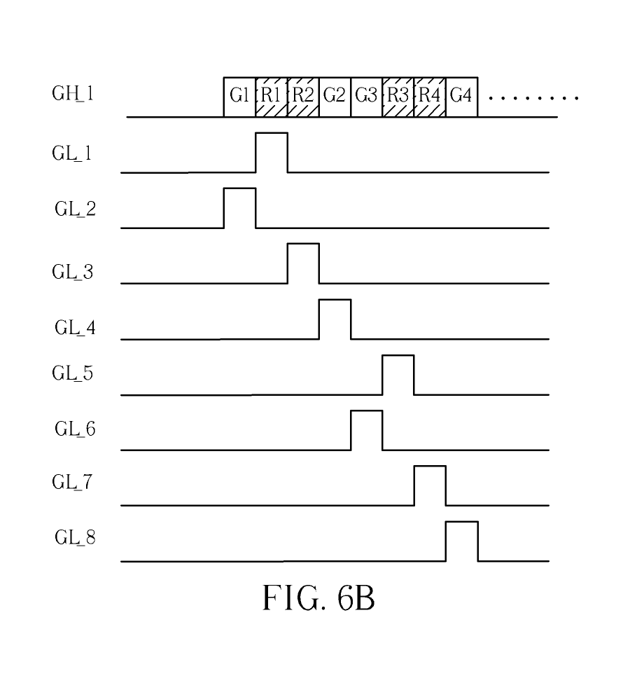

In addition, pixels deposited in the same row and corresponding to the same data line can be charged in different charging sequences in two adjacent frames, so as to avoid brighter or darker pixels fixed on the same position by charging more or less in interlaced time. For example, please refer to FIG. 6A and FIG. 6B, which are schematic diagrams of output signals of the scan lines GL_1-GL_8 and the data line CH_1 in an odd frame and an even frame, respectively, when pixels are driven in a “222-555” sequence. As shown in FIG. 6A and FIG. 6B, in the odd frame, an enable sequence of the scan lines GL_1-GL_q is GL_1→GL_2→GL_4→GL_3→ . . . , i.e. the pixels are charged in a sequence of R1→G1→G2→R2 . . . ; in the even frame, an enable sequence of the scan lines GL_1-GL_q is GL_2→GL_1→GL_3→GL_4→ . . . , i.e. the pixels are charged in a sequence of G1→R1→R2→G2 . . . . As a result, the pixels (e.g. the pixels R1, G1) deposited in the same row and corresponding to the same data line are charged in different charging sequences (e.g. alternating R1→G1 and G1→R1) in the odd frame and the frame, so as to avoid brighter or darker pixels fixed on the same position. By the same token, a “255-522” sequence or a “252-525” sequence can be applied for driving pixels with the same effect.

Therefore, by charging the pixels deposited in different rows and corresponding to the same data line in different charging sequences, the driving module 30 can avoid bright and dark lines on the LCD panel 32. Noticeably, the driving module 30 is only utilized for illustrating operations of the present invention, and is not limited to be realized by software or hardware. Those skilled in the art may make proper modifications or adjust conventional driving modules to realize the driving module 30 according to system requirements. For example, if the source driver 100 and the gate driver 102 in FIG. 1 only have a signal amplification function (i.e. the data driving signals Data_1-Data_p and the gate driving signals Gate_1-Gate_q sent to the scan lines GL_1-GL_q are generated by the timing controller 104), the function of the driving module 30 can be achieved by modifying a signal output sequence of the timing controller 104, or by modifying internal circuits of the source driver 100 and the gate driver 102 instead of the signal output sequence of the timing controller 104. Otherwise, if the source driver 100 and the gate driver 102 in FIG. 1 have both signal amplification and processing functions (i.e. the timing controller 104 only outputs display data and timing), the function of the driving module 30 can be achieved by modifying signal processing logics of the source driver 100 and the gate driver 102. All of the above description is directed to charging the pixels deposited in different rows and corresponding to the same data line in different charging sequences, so as to eliminate bright and dark lines.

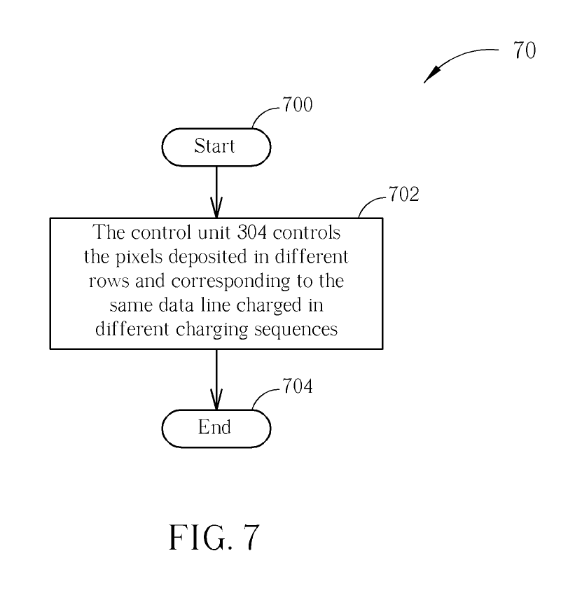

Operations of the driving module 30 can be summarized into a driving process 70. As shown in FIG. 7, the driving process 70 includes the following steps:

Step 700: Start.

Step 702: The control unit 304 controls the pixels deposited in different rows and corresponding to the same data line charged in different charging sequences.

Step 704: End.

The driving process 70 can be referred from the above description, and is not narrated hereinafter.

For the LCD panel with a dual gate structure, pixels are charged in the Z-shaped driving sequence in the prior art. Therefore the pixels deposited on each row and corresponding to the same data line are charged with the same sequence, such that the pixels on one side of the data line are charged more (or less), causing vertical bright and dark lines. In comparison, the present invention charges the pixels deposited in different rows and corresponding to the same data line with different charging sequences, such that pixels on one side of the data line are not charged more (or less), so as to eliminate vertical bright and dark lines. In addition, the present invention can further control pixels deposited in the same row and corresponding to the same data line charged in different charging sequences in two adjacent frames, to avoid brighter or darker pixels fixed on the same position.

To sum up, the present invention can eliminate vertical bright and dark lines, and brighter or darker pixels fixed on the same position.

Those skilled in the art will readily observe that numerous modifications and alterations of the device and method may be made while retaining the teachings of the invention.

What is claimed is:

1. A driving method, for eliminating bright and dark lines in a liquid crystal display (LCD) device, the driving method comprising:
utilizing different charging sequences to charge a plurality of pixels deposited in a first row and corresponding to a data line and a plurality of pixels deposited in a second row and corresponding to the data line.

2. The driving method of claim 1, wherein the first row and the second row are adjacent rows.

3. The driving method of claim 1 further comprising utilizing the same or different charging sequences to charge the plurality of pixels deposited in the first row and corresponding to the data line in two adjacent frames.

4. The driving method of claim 1 further comprising utilizing the same or different charging sequences to charge a plurality of pixels deposited in the same row and corresponding to different data lines.

5. A driving module, for eliminating bright and dark lines in a liquid crystal display (LCD), the driving module comprising:
a data line signal processing unit, for generating a plurality of data driving signals according to a synchronization signal;
a scan line signal processing unit, for generating a plurality of gate driving signals according to an output enable signal; and
a control unit, for generating the synchronization signal and the output enable signal, to control the data line signal processing unit and the scan line signal processing unit, to utilize different charging sequences to charge a plurality of pixels deposited in a first row and corresponding to a data line and a plurality of pixels deposited in a second row and corresponding to the data line.

6. The driving module of claim 5, wherein the first row and the second row are adjacent rows.

7. The driving module of claim 5, wherein the control unit is further utilized for controlling the data line signal processing unit and the scan line signal processing unit, to utilize the same or different charging sequences to charge the plurality of pixels deposited in the first row and corresponding to the data line in two adjacent frame.

8. The driving module of claim 5, wherein the control unit is further utilized for controlling the data line signal processing unit and the scan line signal processing unit, to utilize the same or different charging sequences to charge a plurality of pixels deposited in the same row and corresponding to different data lines.

9. The driving module of claim 5 installed within a timing controller of the LCD device.
